(19) United States
(12) Patent Application Publication
(10) Pub. No.: US 2007/0281076 A1
(43) Pub. Date: Dec. 6, 2007

(54) Organic electroluminescent device and production method thereof

(76) Inventors: Daisuke Okuda, Kanagawa (JP); Katsuhiro Sato, Kanagawa (JP); Kiyokazu Mashimo, Kanagawa (JP); Takeshi Agata, Kanagawa (JP); Toru Ishii, Kanagawa (JP); Akira Imai, Kanagawa (JP); Tadayoshi Ozaki, Kanagawa (JP); Hidekazu Hirose, Kanagawa (JP); Hirohito Yoneyama, Kanagawa (JP); Mieko Seki, Kanagawa (JP); Yohei Nishino, Kanagawa (JP); Koji Horiba, Kanagawa (JP)

Correspondence Address: FILDES & OUTLAND, P.C.;Christopher J. Fildes, Suite 2, 20916 Mack Avenue, Grosse Pointe Woods, MI, 48236, US

(21) Appl. No.: 11/653,543

(22) Filed: Jan. 16, 2007

(30) Foreign Application Priority Data
Jan. 18, 2006 (JP) 2006-009888

(51) Int. Cl. H01J 1/63; B05D 5/12

(52) U.S. Cl. 427/66; 313/504

(57) ABSTRACT

An organic electroluminescent device includes one or more organic compound layers sandwiched between a pair of electrodes, at least one of the electrodes being transparent or semi-transparent, wherein there is provided a layer containing a charge transport polyester comprising a repeating unit containing at least one type selected from structures represented by the following formulae (I-1) and (I-2), as a substructure, so as to be in contact with at least one electrode of the pair of electrodes; and a difference between the ionization potential of the charge transport polyester contained in the layer in contact with the one electrode, and the work function of the surface of the one electrode is within a range of from 0 eV to 0.7 eV. 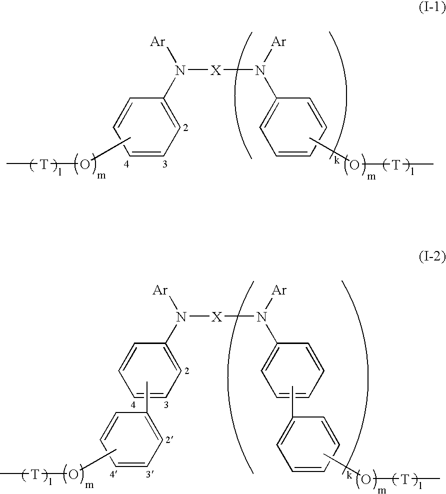 (in the formulae (I-1) and (I-2), Ar represents a substituted or unsubstituted monovalent aromatic group, X represents a substituted or unsubstituted divalent aromatic group, k, m, and l represent 0 or 1, and T represents a divalent linear hydrocarbon having 1 to 6 carbon atoms or a branched hydrocarbon having 2 to 10 carbon atoms.)

### BACKGROUND

1. Technical Field

The present invention relates to an organic electroluminescent device (hereunder, also referred to as an “organic EL device”) and a production method thereof, and specifically to an organic EL device using a specific charge transport polymer.

2. Related Art

Electroluminescent devices (hereunder, referred to as “EL devices”), which are spontaneous-luminescent all solid state devices, can provide high visibility and high impact resistance and therefore are expected to find wide applications. The EL devices with inorganic fluorescent materials are currently dominant, however they have problems such as a high manufacturing cost due to the requirement of an AC voltage of 200V or more for driving, and an insufficient brightness.

In a lamination type EL device, holes and electrons are injected from an electrode through a charge transport layer comprising a charge transport organic compound, while keeping a carrier balance between holes and electrons, into a light emitting layer comprising a fluorescent organic compound, and the holes and the electrons confined in the light emitting layer recombine to realize light emission of a high brightness.

However, the EL device of this type involves the following two main problems for commercialization:

(1) As the device is driven with a high current density of several mA/cm², a large amount of Joule's heat is generated. Therefore, the charge transport low-molecular compound and the fluorescent organic low-molecular compound, formed in thin films of an amorphous state by deposition, gradually crystallize and finally melt to often result in a loss of brightness or a dielectric breakdown, thereby decreasing the service life of the device:

(2) In the production of the device, as thin films of 0.1 μm or less of low-molecular organic compounds are formed in plural deposition steps, pinholes are easily generated, and film thickness control under strictly managed conditions is required for obtaining sufficient performance. Therefore, productivity is low and a large-area device is difficult to prepare.

Here, in order to solve the abovementioned problem shown in (1), for example, there are reported an EL device using a star burst amine capable of providing a stable amorphous glass state as a hole-transport material, and an EL device using a polymer in which triphenylamine is introduced in a side chain of polyphosphazene.

However, in such a material, when employed singly, is unable to provide a satisfactory hole injecting property from an anode or into a light emitting layer because of the presence of an energy barrier resulting from an ionization potential of the hole transport material. Moreover, the former star burst amine has a problem of difficulty in purity improvement since purification is difficult because of a low solubility, while the latter polymer has a problem of being unable to provide a sufficient brightness because a high current density can not be obtained.

Moreover, in order to solve the abovementioned problem shown in (2), research and development have been progressively conducted on organic EL devices of a single layer structure in which the production process can be simplified, and there are proposed a device using a conductive polymer such as poly(p-phenylenevinylene) and a device in which an electron transport material and a fluorescent dye are mixed in a hole-transport polyvinylcarbazole; however such devices are still inferior in brightness and light emitting efficiency, to the lamination type organic EL device using low-molecular weight organic compounds.

Furthermore, in the production method, a coating process using a wet-process is preferred from the viewpoints of simpler production, workability, larger area, lower cost, and the like, and it is reported that a device can be also obtained by a casting process. However there is still a problem regarding production and characteristics because the charge transport material is poor in solubility or compatibility with respect to the solvent or resin, and thus easily crystallizes.

### SUMMARY

According to an aspect of the invention, there is provided an organic electroluminescent device including one or more organic compound layers sandwiched between a pair of electrodes, at least one of the electrodes being transparent or semi-transparent,

the organic compound layers including a layer that is in contact with at least one electrode of the pair of electrodes and includes a charge transport polyester, the charge transport polyester including a repeating unit that includes a structure represented by the following formulae (I-1) or (I-2) as a substructure, and a difference between an ionization potential of the charge transport polyester contained in the layer in contact with the one electrode, and a work function of a surface of the one electrode is within a range of from 0 eV to 0.7 eV.

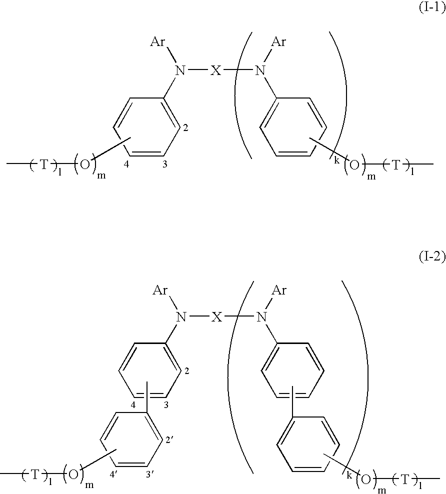

in formulae (I-1) and (I-2), Ar representing a substituted or unsubstituted monovalent aromatic group; X representing a substituted or unsubstituted divalent aromatic group; k, m, and l each independently representing 0 or 1; and T representing a divalent linear hydrocarbon having 1 to 6 carbon atoms or a divalent branched hydrocarbon having 2 to 10 carbon atoms.

### BRIEF DESCRIPTION OF THE DRAWINGS

FIG. 1 is a schematic diagram showing an example of the layer structure of an organic electroluminescent device according to an aspect of the present invention.

FIG. 2 is a schematic diagram showing another example of the layer structure of the organic electroluminescent device according to an aspect of the present invention.

FIG. 3 is a schematic diagram showing yet another example of the layer structure of the organic electroluminescent device according to an aspect of the present invention.

FIG. 4 is a schematic diagram showing yet another example of the layer structure of the organic electroluminescent device according to an aspect of the present invention.

### DETAILED DESCRIPTION

Hereunder is a detailed description of aspects of the present invention.

An organic EL device according to an aspect of the present invention is an organic electroluminescent device comprising one or more organic compound layers sandwiched between a pair of electrodes, at least one of the electrodes being transparent or semi-transparent, wherein there is provided a layer containing a charge transport polyester comprising a repeating unit containing at least one type selected from structures represented by the following formulae (I-1) and (I-2), as a substructure, so as to be in contact with at least one electrode of the pair of electrodes; and a difference between the ionization potential of the charge transport polyester contained in the layer in contact with the one electrode, and the work function of the surface of the one electrode is within a range of from 0 eV to 0.7 eV.

In aspects of the present invention, the layer containing the charge transport polyester may be provided so as to be in contact with both of the pair of electrodes. In this case, more preferably, a difference between the work function of the surfaces of both electrodes and the ionization potential of the charge transport polyester contained in the layer provided in contact with the electrode surfaces is within a range of from 0 eV to 0.7 eV.

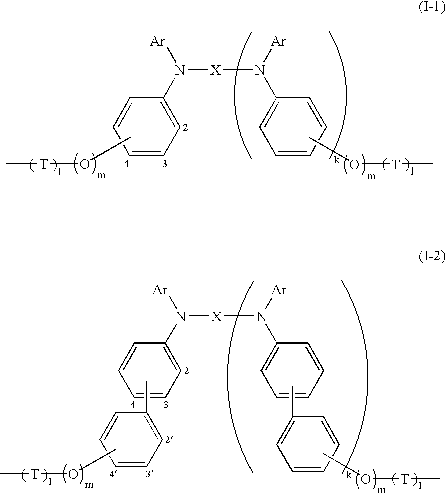

In the above formulae (I-1) and (I-2), Ar represents a substituted or unsubstituted monovalent aromatic group. Specifically, Ar may represent a substituted or unsubstituted phenyl group, a substituted or unsubstituted monovalent polynuclear aromatic hydrocarbon having 2 to 10 aromatic rings, a substituted or unsubstituted monovalent condensed ring aromatic hydrocarbon having 2 to 10 aromatic rings, a substituted or unsubstituted monovalent aromatic heterocycle, or a substituted or unsubstituted monovalent aromatic group containing at least one type of an aromatic heterocycle.

Here, in the formulae (I-1) and (I-2), the number of the aromatic rings constituting the polynuclear aromatic hydrocarbon or the condensed ring aromatic hydrocarbon, selected as a structure represented by Ar, is not particularly limited, however the number of the aromatic rings may be from 2 to 5, and, in the case of the condensed ring aromatic hydrocarbon, a condensed ring aromatic hydrocarbon whose rings are all condensed is preferred. In the invention, specifically, the polynuclear aromatic hydrocarbon and the condensed ring aromatic hydrocarbon mean a polycyclic aromatic group defined as follows.

That is, the “polynuclear aromatic hydrocarbon” means a hydrocarbon compound containing two or more aromatic rings which are constituted of carbon and hydrogen and which are mutually bonded by a carbon-carbon single bond. Specific examples include biphenyl and terphenyl.

Moreover, the “condensed ring aromatic hydrocarbon” means a hydrocarbon compound containing two or more aromatic rings which are constituted of carbon and hydrogen and which own in common a pair of adjacent and bonded carbon atoms. Specific examples include naphthalene, anthracene, phenanthrene and fluorene.

In the formulae (I-1) and (I-2), an aromatic heterocycle selected as one of the structures represented by Ar represents an aromatic ring containing an element other than carbon and hydrogen. The number (Nr) of atoms constituting such cyclic skeleton may be Nr=5 and/or 6. The type and number of the ring-constituting elements other than C (hetero atom) are not particularly limited, however S, N, O and the like may be used, and the ring skeleton may contain hetero atoms of two or more kinds and/or two or more in number. In particular, a heterocycle having a 5-membered structure may be thiophene, thiophine, furan, a heterocycle obtained by substituting a carbon atom in 3- or 4-position thereof with a nitrogen atom, pyrrole, or a heterocycle obtained by substituting a carbon atom in 3- or 4-position thereof with a nitrogen atom, and a heterocycle having a 6-membered structure is preferably pyridine.

In the formulae (I-1) and (I-2), an aromatic group containing an aromatic heterocycle selected as one of the structures represented by Ar represents a bonding group containing at least one type of the aromatic heterocycle in an atomic group constituting the skeleton. Such a group may be entirely constituted of a conjugate system or may be partially constituted of a non-conjugate system, however it is preferably entirely constituted of a conjugate system from the point of the charge transporting ability and the light emitting efficiency.

Examples of a substituent of the benzene ring, the polycyclic aromatic hydrocarbon, the condensed ring aromatic hydrocarbon, or the heterocycle, selected as the structure represented by Ar include a hydrogen atom, an alkyl group, an alkoxy group, a phenoxy group, an aryl group, an aralkyl group, a substituted amino group, and a halogen atom. The alkyl group may have 1 to 10 carbon atoms, examples of which include a methyl group, an ethyl group, a propyl group, and an isopropyl group. The alkoxy group may have 1 to 10 carbon atoms, examples of which include a methoxy group, an ethoxy group, a propoxy group, and an isopropoxy group. The aryl group may have 6 to 20 carbon atoms, examples of which include a phenyl group and a toluoyl group. The aralkyl group may have 7 to 20 carbon atoms, examples of which include a benzyl group and a phenetyl group. Examples of the substituent of the substituted amino group include an alkyl group, an aryl group, and an aralkyl group. Specific examples thereof are as described above.

X represents a substituted or unsubstituted divalent aromatic group. Specifically, X may represent a substituted or unsubstituted phenylene group, a substituted or unsubstituted divalent polynuclear aromatic hydrocarbon having 2 to 10 aromatic groups, a substituted or unsubstituted divalent condensed ring aromatic hydrocarbon having 2 to 10 aromatic groups, a substituted or unsubstituted divalent aromatic heterocycle, or a substituted or unsubstituted divalent aromatic group containing at least one type of an aromatic heterocycle.

Here, the “polynuclear aromatic hydrocarbon”, the “condensed ring aromatic hydrocarbon”, the “aromatic heterocycle”, and the “aromatic group containing an aromatic heterocycle” are the same as those explained above.

In the formulae (I-1) and (I-2), k, m and l represent 0 or 1; and T represents a divalent linear hydrocarbon having 1 to 6 carbon atoms or a branched divalent hydrocarbon having 2 to 10 carbon atoms. Specific structures of T are as follows:

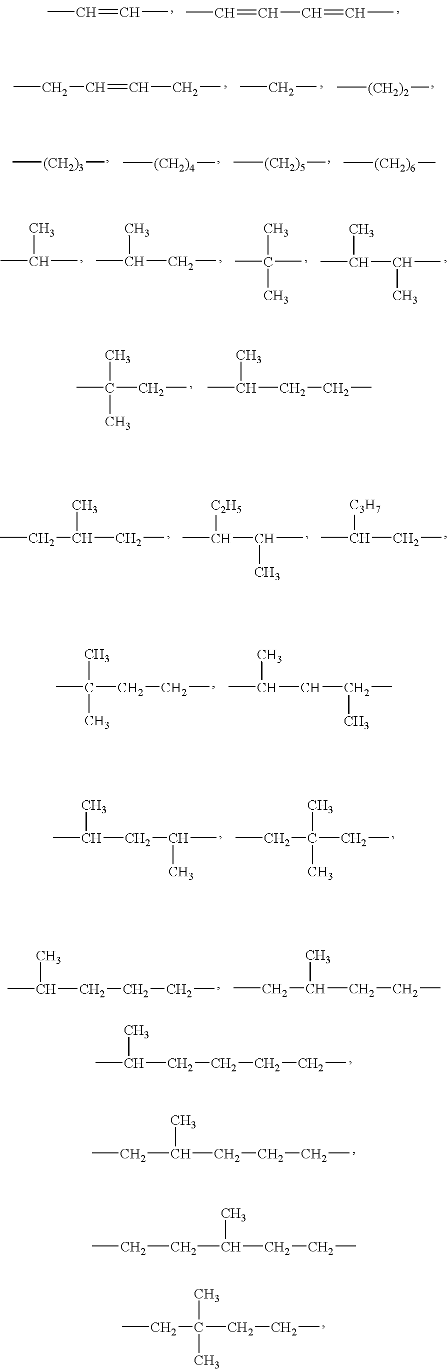

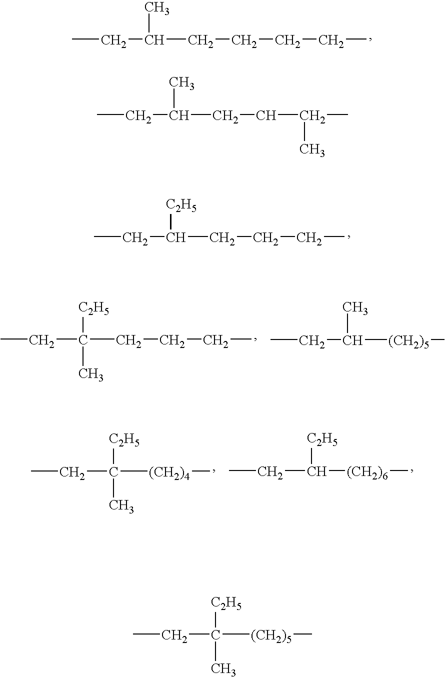

Moreover, as the charge transport polyester comprising a repeating unit containing at least one type selected from structures represented by the formulae (I-1) and (I-2), as a substructure, those represented by the following formula (II-1) or (II-2) are suitably used.

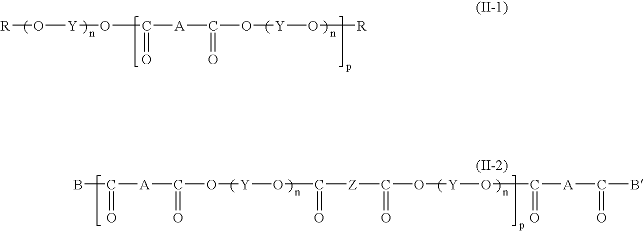

In the formulae (II-1) and (II-2), A represents at least one type selected from structures represented by the above formulae (I-1) and (I-2). One polymer may contain two or more types of structures A.

Moreover, in the formulae (II-1) and (II-2), R represents a hydrogen atom, an alkyl group, a substituted or unsubstituted aryl group, or a substituted or unsubstituted aralkyl group. The alkyl group may have 1 to 10 carbon atoms, examples of which include a methyl group, an ethyl group, a propyl group, an isopropyl group, a butyl group, an octyl group, and a 2-ethyl-hexyl group. The aryl group may have 6 to 20 carbon atoms, examples of which include a phenyl group and a toluoyl group. The aralkyl group may have 7 to 20 carbon atoms, examples of which include a benzyl group and a phenetyl group. Examples of the substituent of the substituted aryl group and the substituted aralkyl group include a hydrogen atom, an alkyl group, an alkoxy group, a substituted amino group, and a halogen atom.

In the formulae (II-1) and (II-2), Y represents a divalent alcohol residue and Z represents a divalent carboxylic acid residue. Specific examples of Y and Z include those selected from the following formulae (1) to (7).

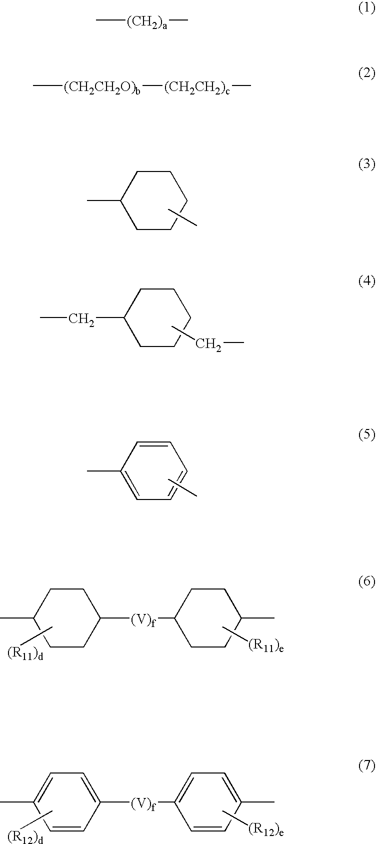

In the formulae (1) to (7), R₁₁ and R₁₂ each represent a hydrogen atom, an alkyl group having 1 to 4 carbon atoms, an alkoxy group having 1 to 4 carbon atoms, a substituted or unsubstituted phenyl group, a substituted or unsubstituted aralkyl group, or a halogen atom; a, b, and c each represent an integer of 1-10; d and e each represent an integer of 0, 1 or 2; f represents an integer of 0 or 1; and V represents a group selected from the following formulae (8) to (18).

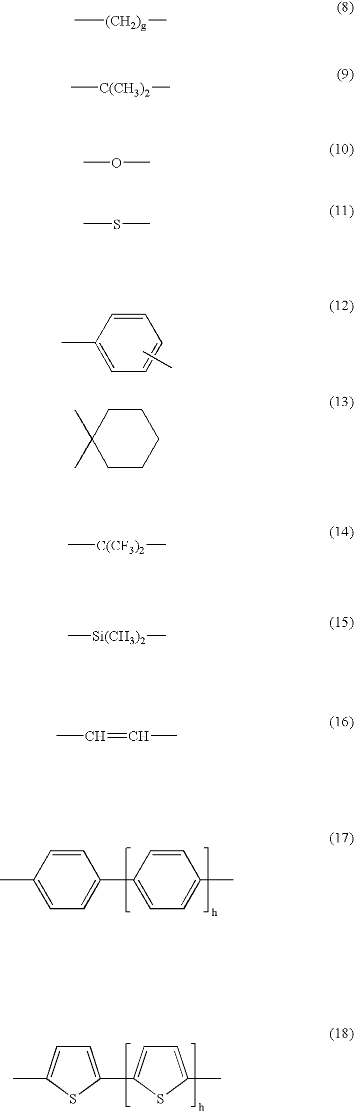

In the formulae (8) to (18), g represents an integer of 1-10; and h represents an integer of 0-10.

In the formulae (II-1) and (II-2), n represents an integer 1 to 5; and p representing the degree of polymerization, is within a range of 5 to 5,000, preferably 10 to 1,000. Moreover, B and B′ each independently represent a —O—(Y—O)ₙ—R group or a —O—(Y—O)ₙ—C O-Z-CO—O—R′ group (wherein the definitions of R, Y, and Z are the same as the above, and R′ represents an alkyl group, a substituted or unsubstituted aryl group, or a substituted or unsubstituted aralkyl group).

The weight-average molecular weight Mw of the charge transport polyester used in aspects of the present invention is preferably within a range of 5,000 to 1,000,000, and more preferably 10,000 to 300,000.

The charge transport polyester used in aspects of the present invention may be synthesized by polymerizing a charge transport monomer represented by the following formulae (III-1) or (III-2) by a known method described for example in Jikken Kagaku Koza, 4th edition, Vol. 28 (Maruzen, 1993). In the formula (III-1) or (III-2), Ar, X, T, k, l, and m are respectively the same as Ar, X, T, k, l, and m in the above formula (I-1) and (I-2), and the scope of A′ includes a hydroxyl group, a halogen, and an alkoxyl group.

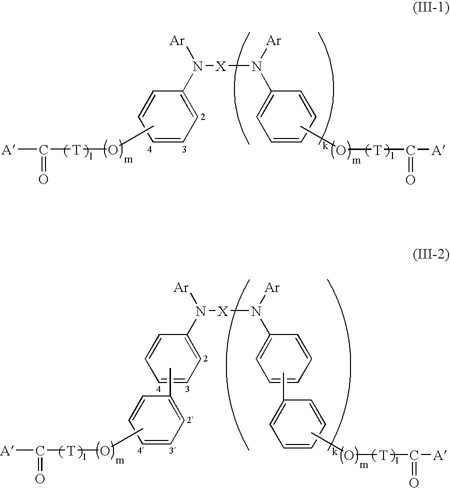

Specifically, the charge transport polyester represented by the formula (II-1) may be synthesized for example, in the following manner.

If A′ is a hydroxyl group, a charge transport monomer is mixed with approximately one equivalent of a dihydric alcohol represented by HO—(Y—O)ₙ—H and polymerized using an acid catalyst. As the acid catalyst, those used in an ordinary esterification reaction may be used such as sulfuric acid, toluenesulfonic acid, and trifluoroacetic acid. The amount of the catalyst is preferably within a range of 1/10,000 to 1/10 parts by weight, and more preferably 1/1,000 to 1/50 parts by weight, with respect to 1 part by weight of the charge transport monomer.

A solvent capable of forming an azeotrope with water may be used in order to eliminate water formed in the polymerization, and there can be advantageously used toluene, chlorobenzene, or 1-chloronaphthalene which is used within a range of 1 to 100 parts by weight, and preferably 2 to 50 parts by weight, with respect to 1 part by weight of the charge transport monomer. The reaction temperature may be arbitrarily set, however the reaction is preferably performed at the boiling point of the solvent in order to eliminate the water generated in the polymerization.

After the reaction, if a solvent is not used, the product is dissolved in a solvent that can dissolve the product. If a solvent is used, the reaction solution is dropwise added to a poor solvent in which a polymer is not easily dissolved, for example alcohols such as methanol and ethanol, and acetones, thereby precipitating the hole-transport polyester and separating the charge transport polyester, which is then sufficiently washed with water or an organic solvent and dried. If necessary, there may be repeated a reprecipitation process of dissolving the polyester in an appropriate organic solvent and adding it dropwise into a poor solvent thereby precipitating the charge transport polyester. Such a reprecipitation process may be performed under efficient agitation for example with a mechanical stirrer.

The amount of solvent for dissolving the charge transport polyester at the time of the reprecipitation process is preferably within a range of 1 to 100 parts by weight, and more preferably 2 to 50 parts by weight, with respect to 1 part by weight of the charge transport polyester. Moreover, the amount of the poor solvent is preferably within a range of 1 to 1,000 parts by weight, and more preferably 10 to 500 parts by weight, with respect to 1 part by weight of the charge transport polyester.

If A′ is a halogen, a charge transport monomer is mixed with approximately one equivalent of a dihydric alcohol represented by HO—(Y—O)ₙ—H and polymerized with an organic basic catalyst such as pyridine and triethylamine. The amount of the organic basic catalyst is preferably within a range of 1 to 10 equivalents, and more preferably 2 to 5 equivalents with respect to 1 equivalent of the hole-transport monomer.

As the solvent, effective ones are for example methylene chloride, tetrahydrofuran (THF), toluene, chlorobenzene, and 1-chloronaphthalene. The amount of the solvent is preferably within a range of 1 to 100 parts by weight, and more preferably 2 to 50 parts by weight, with respect to 1 part by weight of the charge transport monomer. The reaction temperature may be arbitrarily set. After the polymerization, purification is performed by a reprecipitation process as described above.

In the case of a dihydric alcohol of a high acidity such as bisphenol, interfacial polymerization may also be used. That is, a dihydric alcohol is added to water and dissolved by adding one equivalent of a base, and polymerization may be performed by adding a solution of one equivalent of charge transport monomer to the dihydric alcohol, under vigorous agitation. At this time, the amount of water is preferably within a range of 1 to 1,000 parts by weight, and more preferably 2 to 500 parts by weight, with respect to 1 part by weight of the dihydric alcohol.

As to the solvent for dissolving the charge transport polyester, effective ones are for example methylene chloride, dichloroethane, trichloroethane, toluene, chlorobenzene, and 1-chloronaphthalene. The reaction temperature may be arbitrarily set. In order to accelerate the reaction, it is effective to employ an interphase movable catalyst such as an ammonium salt or a sulfonium salt. The amount of the interphase movable catalyst is preferably within a range of 0.1 to 10 parts by weight, and more preferably 0.2 to 5 parts by weight, with respect to 1 part by weight of the hole-transport monomer.

Furthermore, if A′ is an alkoxyl group, the synthesis may be performed by adding an excessive amount of dihydric alcohol represented by HO—(Y—O)ₙ—H to a charge transport monomer represented by the above formulae (III-1) or (III-2), and performing an ester exchange under heating in the presence of a catalyst for example an inorganic acid such as sulfuric acid and phosphoric acid, titanium alkoxide, an acetate or carbonate of calcium or cobalt, or a zinc or lead oxide.

The amount of the dihydric alcohol is preferably within a range of 2 to 100 equivalents, and more preferably 3 to 50 equivalents, with respect to 1 equivalent of the charge transport monomer. The amount of the catalyst is preferably within a range of 1/10,000 to 1 part by weight, and more preferably 1/1,000 to ½ parts by weight, with respect to 1 part by weight of the charge transport monomer.

The reaction is performed at a temperature of 200 to 300° C. At the completion of ester exchange from an alkoxyl group into an O—(Y—O)ₙ—H group, the reaction may be performed under a reduced pressure in order to accelerate polymerization by elimination. It is also possible to employ a solvent having a high boiling point capable of forming an azeotrope with the HO—(Y—O)ₙ—H such as 1-chloronaphthalene, to perform a reaction while eliminating the HO—(Y—O)ₙ—H by azeotropy under an atmospheric pressure.

Moreover, the charge transport polyester represented by the formula (II-2) may be synthesized in the following manner.

That is, in the aforementioned respective cases of the synthesis of the charge transport polyester represented by the formula (II-1), the reaction is performed by adding an excessive amount of dihydric alcohol, to generate compounds represented by the following formulae (IV-1) and (IV-2), which are used as the charge transport monomer. In the same manner as that mentioned above, the charge transport monomer may be reacted with a divalent carboxylic acid or a divalent carboxylic acid halide, and thereby the charge transport polyester can be obtained. In the formulae (IV-1) and (IV-2), Ar, X, T, k, l, m, Y, and n are respectively the same as those represented in the formula (I-1), (I-2), (II-1), and (II-2).

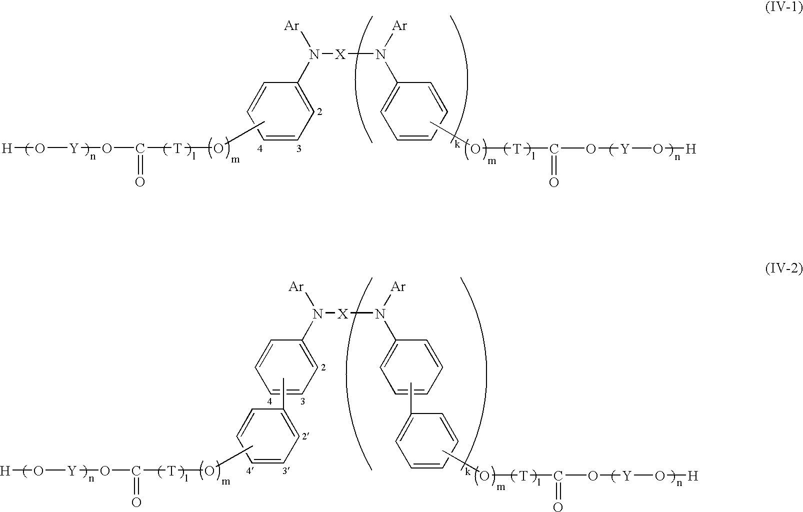

Next is a description of a method for producing the organic EL device according to an aspect of the present invention, and various materials used for forming an organic EL device according to an aspect of the present invention except for the abovementioned charge transport polyester.

An organic EL device according to an aspect of the present invention comprising one or plural organic compound layers sandwiched between a pair of electrodes, at least one of the electrodes being transparent or semi-transparent, may be formed through at least a coating step of coating a solution containing the abovementioned charge transport polyester comprising a repeating unit containing at least one type selected from structures represented by the formulae (I-1) and (I-2), as a substructure, onto a surface of at least one electrode of the pair of electrodes. In this case, a difference between the ionization potential of the charge transport polyester contained in the solution, and the work function of the surface of the one electrode immediately before coating with the solution is preferably within a range of from 0 eV to 0.7 eV, and more preferably from 0 eV to 0.4 eV.

Therefore, the charge injecting property may be improved, resulting in improvement of various properties of an EL device such as the driving voltage, the brightness, and the service life. Moreover, since there is used a device structure where a layer containing a charge transport polyester is provided to be in contact with the electrode, the number of layers may be reduced, simplifying the device structure and improving the productivity of the device.

Here, in the present invention, “one electrode surface immediately before coating with a solution (containing charge transport polyester)” means a state of surface that is substantially the same as the electrode surface when a solution is actually being coated thereon. Specifically, it means the electrode surface right after a last treatment (such as wet washing or surface treatment) which changes the state of the electrode surface, and before coating the solution. In the present invention, the work function of the electrode surface and the contact angle of the electrode surface for water mean values measured on the electrode surface satisfying such a condition.

Moreover, if the organic electroluminescent device according to an aspect of the present invention is formed through at least a step of forming an electrode on the surface of the layer containing the charge transport polyester comprising a repeating unit containing at least one type selected from structures represented by the formulae (I-1) and (I-2), as a substructure, by means of deposition or the like, then a difference between the ionization potential of the charge transport polyester contained in the layer, and the work function of the electrode surface formed on this layer surface is preferably within a range of from 0 eV to 0.7 eV, and more preferably from 0 eV to 0.4 eV. However, if it is formed through such a process, the “work function of the electrode surface (work function of the surface of the electrode)” means substantially a work function of an electrode material constituting the electrode.

Furthermore, if the layer containing the charge transport polyester is provided to be in contact with both of the pair of electrode surfaces, a difference between the ionization potential of the charge transport polyester contained in the layer provided to be adjacent to the electrodes, and the work function of the electrode surfaces adjacent to this layer is within a range of 0 eV to 0.7 eV, at least one part of (i) the side of the “electrode/layer containing charge transport polyester” that is formed by coating a layer containing a charge transport polyester onto the electrodes, or (ii) the side of a “layer containing charge transport polyester/electrode” that is formed by forming the electrodes on the layer containing the charge transport polyester, and is preferably within a range of 0 eV to 0.7 eV, on both parts.

However, in an aspect of the present invention, in at least the side of the “electrode/layer containing charge transport polyester” that is formed by coating a layer containing a charge transport polyester onto the electrodes, a difference between the ionization potential of the charge transport polyester contained in the layer provided to be adjacent to the electrodes, and the work function of the electrode surfaces adjacent to this layer may be within a range of 0 eV to 0.7 eV.

Here, (1) the work function of the electrode surface and (2) the ionization potential of the charge transport polyester are measured by a photoelectron spectrometer (AC-2, manufactured by Riken Keiki) in the air.

Specifically, in the case of (1), a sample is prepared by cutting out a glass substrate with a thickness of 2 mm formed with an electrode, in 2 cm×2 cm. In the case of (2), a sample is prepared by previously dissolving in a predetermined amount of solvent so as to have a thickness within a range of 2 to 10 μm, and forming a layer on an aluminum plate with a thickness of 1 mm in 2 cm×2 cm by spincoating These samples are set in the apparatus, and measurement is performed by a predetermined method according to the instruction manual. In the measurement, the precision gets worse if the yield of photoelectrons exceeds 2000 cps (Count Per Second). Therefore, since the square of the value (cps) is displayed on the apparatus as the value along Y axis, it is preferred to set the quantity of light so that the value of yield of photoelectrons does not exceed 45 (=square of 2000 cps) On the other hand, since the lower limit differs depending on the sample, the value can not be unequivocally defined, however it may be of an extent which allows signals emitted from photoelectrons to be detected.

Moreover, at the time of measurement, it is effective to start sweeping sufficiently below the threshold of the photoelectron emission so as to have an enough baseline.

As an electrode material satisfying the work function having a difference from the ionization potential of the charge transport polyester contained in the layer adjacent to the electrode within a range of from 0 eV to 0.7 eV, if the electrode is an anode for injecting holes, specifically, there may be used an oxide film such as indium tin oxide (ITO), tin oxide (NESA), indium oxide, zinc oxide, a deposited or sputtered film of gold, platinum, palladium, or the like.

Moreover, if the electrode is a cathode for injecting electrons, there is used a metal having a low work function for performing electron injection, preferably an alkali metal such as lithium and the salt thereof (such as a halide), an alkaline-earth metal such as magnesium and calcium and the salt thereof, aluminum, silver, indium, or an alloy thereof.

Furthermore, in order to adjust the work function of the electrode surface so as to have a difference from the ionization potential of the charge transport polyester adjacent to the electrode within a range of from 0 eV to 0.7 eV, it can be achieved by selecting the electrode material as described above, however, it can be also achieved by performing a surface treatment step of treating the electrode surface, prior to the coating step of coating the electrode surface with a solution containing the charge transport polyester.

Although the number of manufacturing steps is increased due to the introduction of the surface treatment step, it is advantageous since the number of layers constituting the device may be keep from increasing, compared to the case where a step of forming an injection layer comprising an organic compound and an inorganic compound, is introduced so as to obtains a similar effect to that of an aspect of the present invention.

The method of surface treatment is not particularly limited. However, examples thereof include ultraviolet cleaning by means of irradiation with a low-pressure mercury lamp, ultraviolet cleaning by means of irradiation with an excimer lamp, plasma cleaning at ordinary pressure, vacuum plasma cleaning, ozone cleaning, and treatment with a hydrogen gas. At least one type may be utilized from among these methods, and two types of more may be combined.

In particular, if the electrode to be subject to the surface treatment is an anode, the surface treatment is effectively performed onto an electrode surface comprising an oxide film such as indium tin oxide (ITO), tin oxide (NESA), indium oxide, and zinc oxide. Moreover, from the beginning, if a difference between the ionization potential of the charge transport polyester, and the work function of a compound present in the electrode surface in contact with the layer containing the charge transport polyester is within a range of from 0 eV to 0.7 eV, the performance may be further improved even if the surface treatment is further performed, provided that the difference between the ionization potential and the work function does not become greater, compared to before surface treatment.

This effect does not only change the work function of the anode surface, but also is observed as a phenomenon of removing organic substances adhered on the surface so as to clean, and a phenomenon where the surface energy of the electrode surface is changed by the surface treatment, resulting in improvement of the wettability that is found in a decrease of the contact angle for water.

As a result, when the layer containing the charge transport polyester is being formed in contact with the surface treated electrode, the solution is evenly spread to reduce non-uniform coatings, and thereby a good quality of the layer containing the charge transport polyester may be formed on the electrode surface. Moreover, the layer may be thinner, and the applied voltage for the same brightness may be decreased.

Therefore, the electrode surface formed with the layer containing the charge transport polyester is desirably formed from an electrode material having the contact angle for water of from 0 degrees to 30 degrees, and more preferably from 0 degrees to 20 degrees, immediately before coating with a solution containing the charge transport polyester.

If the contact angle exceeds 30 degrees, after the solution containing the charge transport polyester is coated onto the electrode surface, non-uniform coatings are generated, and the layer containing the charge transport polyester may not be formed uniformly on the electrode surface. Therefore, a required applied voltage for achieving a predetermined brightness may be increased.

The contact angle is measured with a CA-X contact angle meter (manufactured by Kyowa Interface Science Co., Ltd.), under conditions where the room temperature is 25° C., a purified water which has been passed through an ion exchange resin and then distilled, is put into a syringe, a droplet with a diameter of 3 graduations of the graduations on the screen is generated at the tip of the syringe, and then operation is performed according to a predetermined instruction manual.

Next is a detailed description of the layer structure of the organic EL device according to an aspect of the present invention.

In the organic electroluminescent device according to an aspect of the present invention, if the organic compound layer has a multiple layer structure (that is, the case of a function separation type where the respective layers have different functions), at least one layer includes a light emitting layer, and this light emitting layer may be a light emitting layer having a charge transporting ability. In this case, specific examples of the layer structure comprising the light emitting layer or the light emitting layer having a charge transporting ability, and other layers include: (1) a layer structure comprising a light emitting layer, an electron transport layer and/or an electron injection layer; (2) a layer structure comprising a hole transport layer and/or a hole injection layer, a light emitting layer, an electron transport layer and/or an electron injection layer; and (3) a layer structure comprising a hole transport layer and/or a hole injection layer, and a light emitting layer. Layers except for the light emitting layer and the light emitting layer having a charge transporting ability of these layer structures (1) to (3) have a function as either a charge transport layer or a charge injection layer.

On the other hand, if the organic compound layer is a single layer, the organic compound layer means a light emitting layer having a charge transporting ability, and this light emitting layer having a charge transporting ability contains the charge transport polyester.

In any layer structure among the layer structures (1) to (3), the charge transport polyester may be contained in at least one layer, however the charge transport polyester is contained in a layer adjacent to at least one of the pair of electrodes.

Moreover, in the organic EL device according to an aspect of the present invention, the light emitting layer, the hole transport layer, the hole injection layer, the electron transport layer, and the electron injection layer may contain a charge transport material (hole transport material and electron transport material other than the charge transport polyester). The details are described later. Hereunder is a more detailed description with reference to the drawings, however it is not to be considered as limiting the present invention.

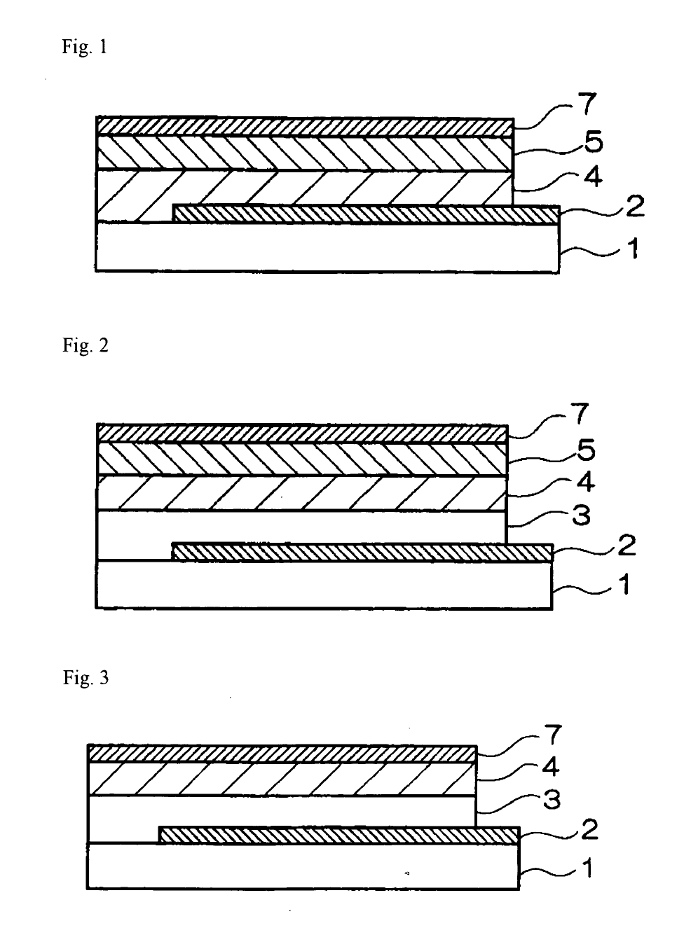

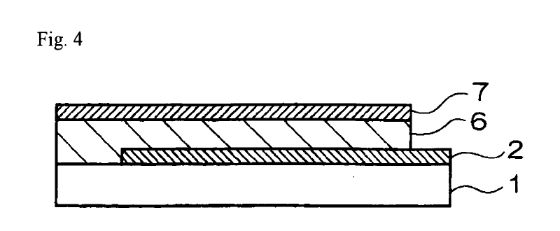

FIG. 1 to FIG. 4 are schematic cross-sectional diagrams for describing the layer structure of the organic EL device according to an aspect of the present invention, wherein FIG. 1, FIG. 2 and FIG. 3 show examples where there are plural organic compound layers, and FIG. 4 shows an example where there is one organic compound layer. In FIG. 1 to FIG. 4, the same reference symbols are used for members having the same function.

In FIG. 1 to FIG. 4, description is performed using the same reference symbols for components having similar functions.

An organic EL device shown in FIG. 1 is formed by laminating, on a transparent insulating substrate 1, in the order of a transparent electrode 2, a light emitting layer 4, an electron transport layer 5, and a rear electrode 7. An organic EL device shown in FIG. 2 is formed by laminating, on a transparent insulating substrate 1, in the order of a transparent electrode 2, a hole transport layer 3, a light emitting layer 4, an electron transport layer 5, and a rear electrode 7. An organic EL device shown in FIG. 3 is formed by laminating, on a transparent insulating substrate 1, in the order of a transparent electrode 2, a hole transport layer 3, a light emitting layer 4, and a rear electrode 7. An organic EL device shown in FIG. 4 is formed by laminating, on a transparent insulating substrate 1, in the order of a transparent electrode 2, a light emitting layer 6 with a charge transporting ability, and a rear electrode 7. In addition to these layers, there are provided a hole injection layer and an electron injection layer as required. Hereunder is a description of each one in detail.

In aspects of the present invention, a layer containing the charge transport polyester, functions according to its layer structure. For example, in the case of the layer structure of the organic EL device shown in FIG. 1, it can function as any of the electron transport layer 5 or the light emitting layer 4 (in this case, it becomes the light emitting layer with a charge transporting ability). In the case of the layer structure of the organic EL device shown in FIG. 2, it can function as any of the hole transport layer 3 or the electron transport layer 5. In the case of the layer structure of the organic EL device shown in FIG. 3, it can function as any of the hole transport layer 3 or the light emitting layer 4 (in this case, it becomes the light emitting layer with a charge transporting ability). In the case of the layer structure of the organic EL device shown in FIG. 4, it can function as the light emitting layer 6 with a charge transporting ability.

Hereunder is a description of materials of the electrode and the respective layers, and the production method thereof.

In the layer structure of the organic EL device shown in FIGS. 1 to 4, the transparent insulating substrate 1 is preferably transparent in order to transmit the emitted light, and there is used glass, plastic film, or the like. The transparent electrode 2 is preferably transparent in order to transmit the emitted light as in the transparent insulating substrate, and preferably has a large work function in order to inject holes, and as described above, there may be used an oxide film such as indium tin oxide (ITO), tin oxide (NESA), indium oxide, zinc oxide, or a deposited or sputtered film of gold, platinum, palladium, or the like.

In the case of the layer structure of the organic EL device shown in FIG. 1 and FIG. 2, the electron transport layer 5 may be singly formed by the abovementioned charge transport polyester provided with a function (electron transporting ability) according to the purpose, however it may also be formed by mixing and dispersing an electron transport material other than the charge transport polyester within a range of 1 to 50 wt. % with respect to the total weight of materials constituting the electron transport layer 5, for regulating the electron mobility, for the purpose of further improving the electrical characteristics.

Suitable examples of such an electron transport material include an oxadiazole derivative, a nitro-substituted fluorenone derivative, a diphenoquinone derivative, a thiopyrandioxide derivative, and a fluorenylidene methane derivative.

Suitable specific examples of the electron transport material include the following compounds (V-1) to (V-4), but such examples are not to be considered as limiting. Moreover, it may be a mixture with an other general purpose resin or the like.

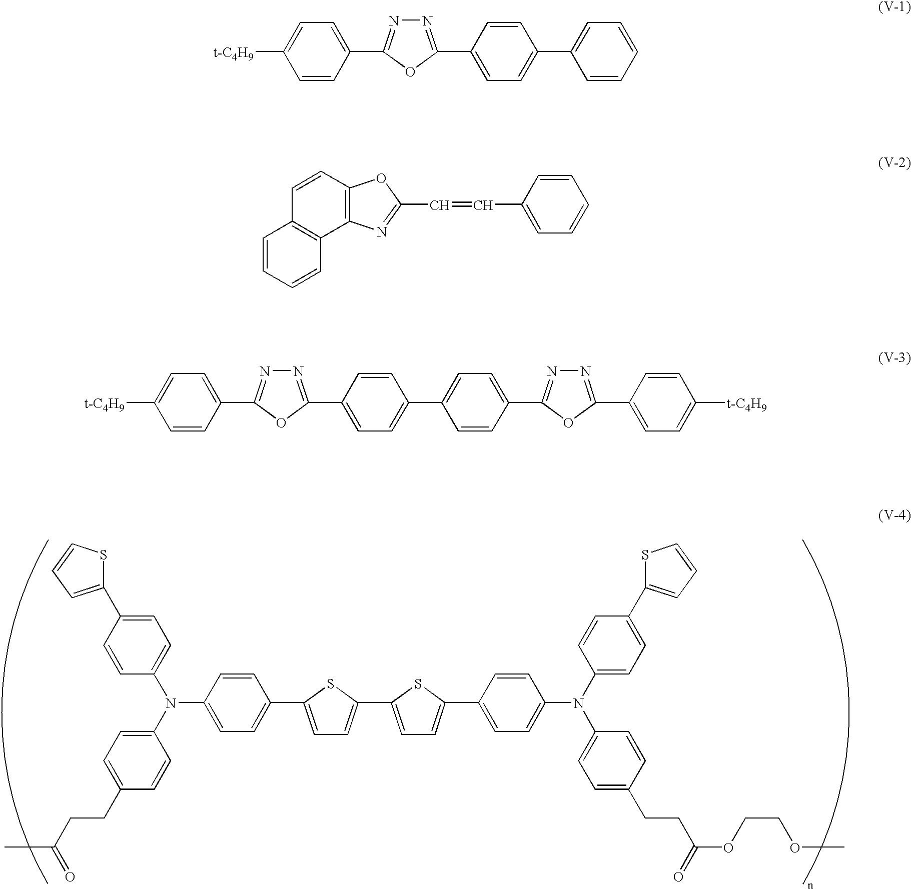

In the case where the electron injection layer is formed between the electron transport layer 5 and the rear electrode 7 for the purpose of improving the electron injecting property from a cathode, the material may be any material having a function of injecting electrons from the cathode. There may be used a similar material to the charge transport polyester and other electron transport materials. However, the injection layer is not necessarily provided.

In the case of the layer structure of the organic EL device shown in FIG. 2 and FIG. 3, the hole transport layer 3 may be singly formed by the abovementioned charge transport polyester provided with a function (hole transporting ability) according to the purpose, however it may also be formed by mixing and dispersing a hole transport material other than the charge transport polyester within a range of 1 to 50 wt. % with respect to the total weight of materials constituting the hole transport layer 3, for regulating the hole mobility.

Suitable examples of such a hole transport material include a tetraphenylenediamine derivative, a triphenylamine derivative, a carbazole derivative, a stilbene derivative, an arylhydrazone derivative, and a porphyrin derivative. Particularly suitable specific examples include the following compounds (VI-1) to (VI-7). However, among them, a tetraphenylenediamine derivative is preferred because of a satisfactory compatibility with the charge transport polyester. Moreover, it may be a mixture with an other general purpose resin or the like. In the formula (VI-7), n means an integer of 1 or more.

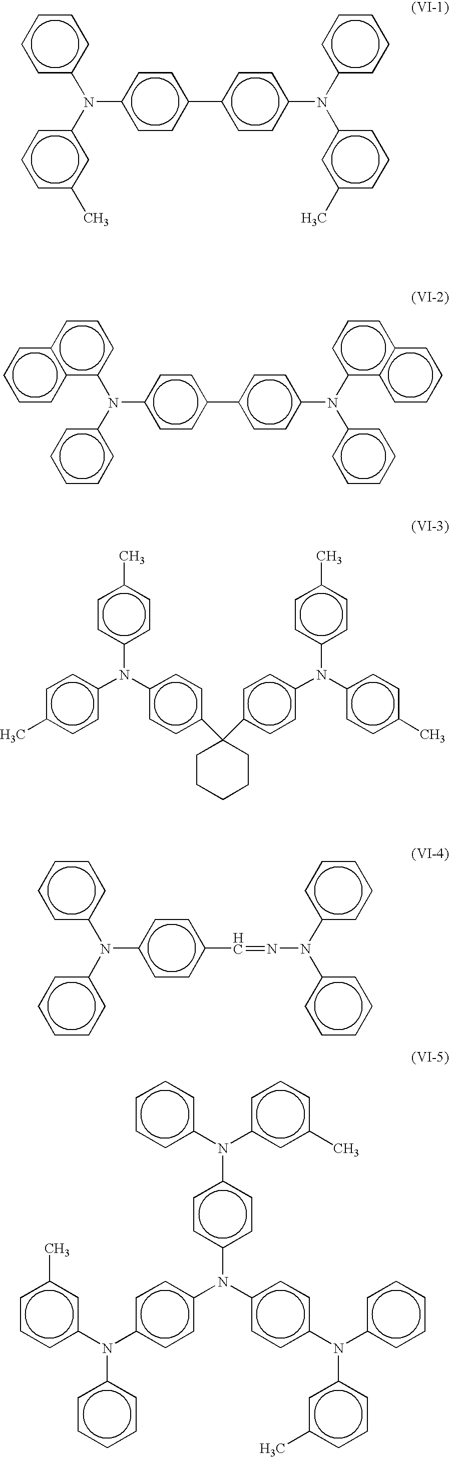

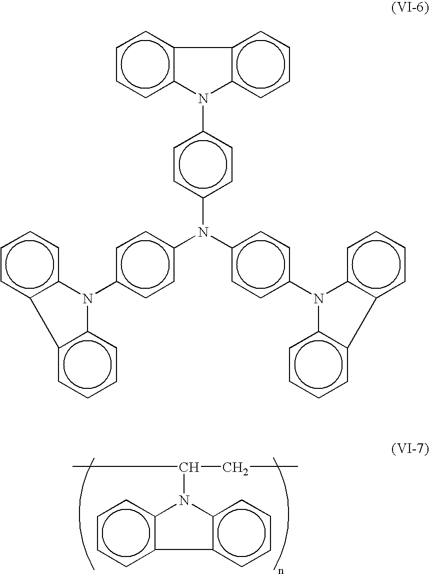

In the case where the hole injection layer is formed between the transparent electrode 2 and the hole transport layer 3 for the purpose of improving the hole injecting property from an anode, the material may be any material having a function of injecting holes from the anode. There may be used a similar material to the charge transport polyester and other hole transport materials. However, the injection layer is not necessarily provided.

In the layer structure of the organic EL device shown in FIG. 1, FIG. 2, and FIG. 3, for the light emitting layer 4, a compound showing a high fluorescence quantum yield in a solid state is used as a light emitting material.

If the light emitting material is an organic low-molecular compound, the condition is such that a satisfactory thin film may be formed by a vacuum vapor deposition method or by coating and drying a solution or a dispersion containing the low-molecular compound and a binder resin.

Moreover, if the light emitting material is a high-molecular compound, the condition is such that a satisfactory thin film may be formed by coating and drying a solution or a dispersion containing such high-molecular compound itself.

If the light emitting material is an organic low-molecular compound, suitable examples thereof include a chelate organometallic complex, a polynuclear or condensed-ring aromatic compound, a perylene derivative, a coumarine derivative, a styrylarylene derivative, a silol derivative, an oxazole derivative, an oxathiazole derivative, and an oxadiazole derivative. In the case of a high-molecular compound, suitable examples thereof include a polyparaphenylene derivative, a polyparaphenylenevinylene derivative, a polythiophene derivative, a polyacetylene derivative, and a polyfluorene derivative. Suitable specific examples include the following compounds (VII-1) to (VII-17), however such examples are not to be considered as limiting.

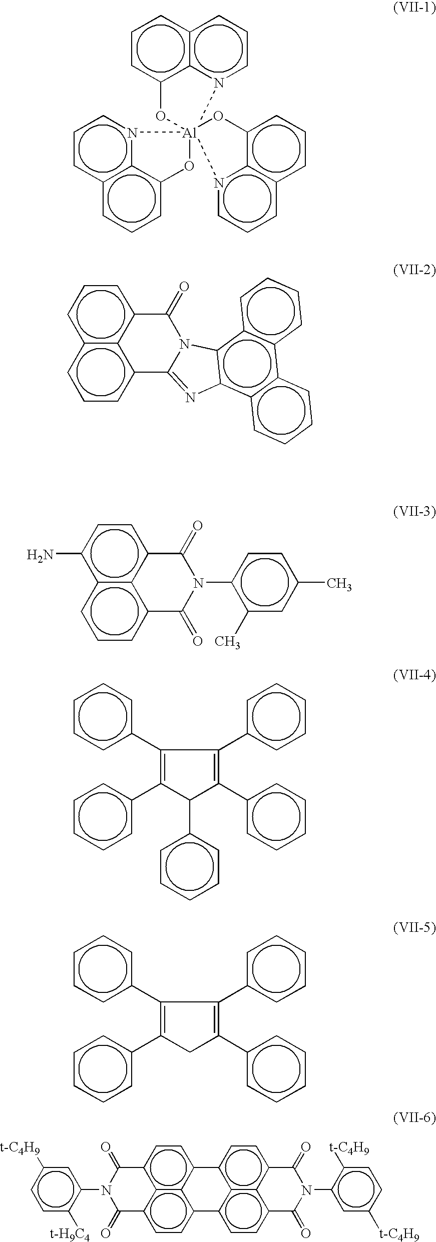

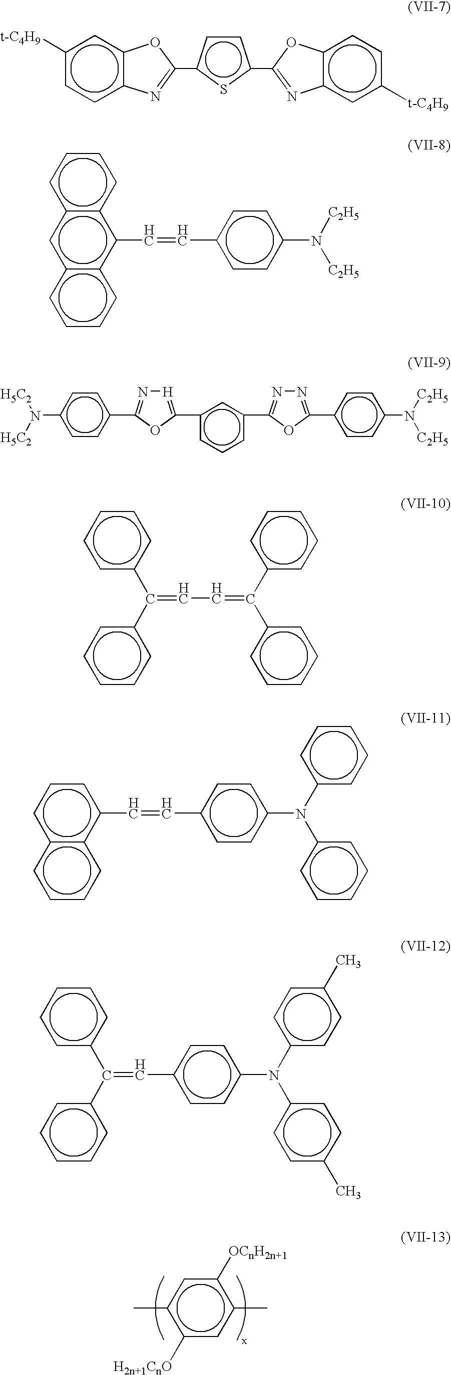

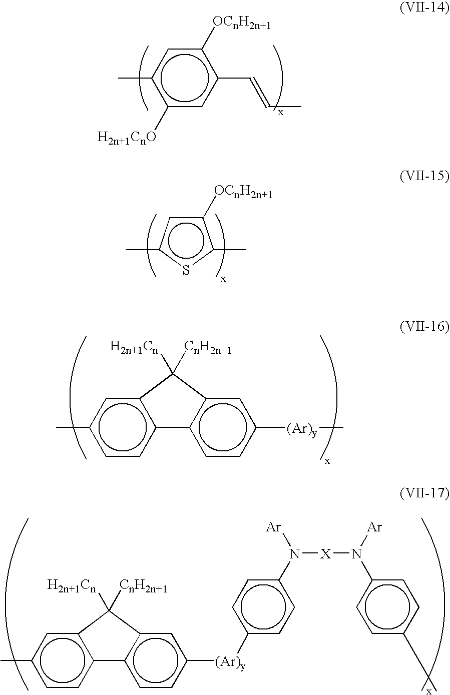

In the formulae (VII-13) to (VII-17), n and x represent an integer of 1 or more, and y represents 0 or 1. In the formulae (VII-16) to (VII-17), Ar represents a substituted or unsubstituted monovalent aromatic group, and X represents a substituted or unsubstituted divalent aromatic group.

Moreover, for the purpose of improving the durability or the light emitting efficiency of the organic EL device, the abovementioned light emitting material may be doped, as a guest material, with a dye compound different from the light emitting material. If the light emitting layer is formed by vacuum deposition, the doping is achieved by co-deposition. If the light emitting layer is formed by coating and drying a solution or a dispersion, the doping is performed by mixing in such solution or dispersion. A doping proportion of the dye compound in the light emitting layer is about 0.01 to 40 wt. %, and preferably about 0.01 to 10 wt. %.

For the dye compound used in such doping, there is used an organic compound having a satisfactory compatibility with the light emitting material and not hindering a satisfactory thin film formation of the light emitting layer, and suitable examples thereof include a DCM derivative, a quinacridone derivative, a rubrene derivative, and a porphyrin derivative. Suitable specific examples thereof include the following compounds (VIII-1) to (VIII-4), however such examples are not to be considered as limiting.

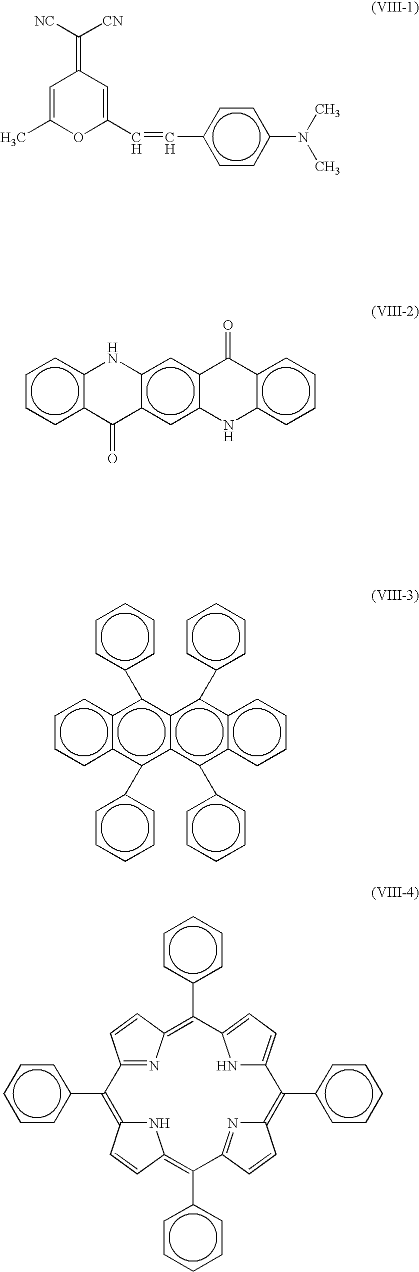

Moreover, the light emitting layer 4 may be singly formed by a light emitting material, however it may also be formed by mixing and dispersing a charge transport polyester in the light emitting material within a range of 1 to 50 wt, or by mixing and dispersing a charge transport material other than the charge transport polyester in the light emitting polymer within a range of 1 to 50 wt. %, for the purpose of further improving the electrical characteristics and the light emitting characteristics. Furthermore, if the charge transport polyester also has a light emitting characteristic, it may be used as the light emitting material. In this case, the light emitting layer may also be formed by mixing and dispersing a charge transport material other than the charge transport polyester in the light emitting material within a range of 1 to 50 wt %, for the purpose of further improving the electrical characteristics and the light emitting characteristics.

In the layer structure of the organic EL device shown in FIG. 4, the light emitting layer 6 with a charge transporting ability is an organic compound layer formed by dispersing the abovementioned light emitting low-molecular compound as the light emitting material in the charge transport polyester provided with a desired function (hole transporting ability or electron transporting ability) according to the purpose, within a range of 0.1 to 50 wt. % with respect to the total weight of materials constituting the light emitting layer 6 with a charge transporting ability. However, in order to regulate the balance of the holes and the electrons injected in the organic EL device, a charge transport material other than the charge transport polyester may be dispersed within a range of 10 to 50 wt. %.

For such a charge transport material, in the case of regulating the electron mobility, examples as the electron transport material suitably include an oxadiazole derivative, a nitro-substituted fluorenone derivative, a diphenoquinone derivative, a thiopyrandioxide derivative, and a fluorenylidene methane derivative. Suitable specific examples thereof include the above compounds (V-1) to (V-3). Moreover, there may be used an organic compound not showing a strong electronic interaction with the charge transport polyester, and more preferably the following compound (IX), however such an example is not to be considered as limiting.

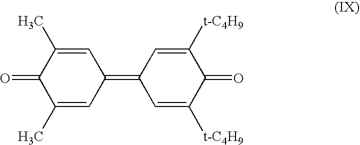

Similarly, in the case of regulating the hole mobility, examples as the hole transport material suitably include a tetraphenylenediamine derivative, a triphenylamine derivative, a carbazole derivative, a stilbene derivative, an arylhydrazone derivative, and a porphyrin derivative. Suitable specific examples thereof include the above compounds (VI-1) to (VI-7), however a tetraphenylenediamine derivative is preferred because of a satisfactory compatibility with the charge transport polyester.

In the layer structure of the organic EL device shown in FIGS. 1 to 4, for the rear electrode 7 is used a metal that can be vacuum deposited and has a low work function for performing electron injection, and as described above, preferable is an alkali metal such as lithium and the salt thereof (such as a halide), an alkaline-earth metal such as magnesium and calcium and the salt thereof, aluminum, silver, indium, or an alloy thereof. On the rear electrode 7 may be provided a protective layer for avoiding deterioration of the device due to moisture or oxygen.

Specific examples of the protective layer material include a metal such as In, Sn, Pb, Au, Cu, Ag, and Al, a metal oxide such as MgO, SiO₂, and TiO₂, and a resin such as polyethylene, polyurea, and polyimide. For forming the protective layer, there may be applied a vacuum vapor deposition method, a sputtering method, a plasma polymerization method, a CVD method, or a coating method.

The respective layers of the organic EL device shown in FIG. 1 to FIG. 4 may be formed in the following procedure. At first, on the transparent electrode 2 is formed the hole transport layer 3, the light emitting layer 4, or the light emitting layer 6 with a charge transporting ability according to the layer structure of the respective organic EL devices. The hole transport layer 3, the light emitting layer 4, and the light emitting layer 6 with a charge transporting ability are formed by a vacuum vapor deposition method with the material constituting the respective layers, or by forming a film on the transparent electrode 2 by spin coating or dip coating with a coating liquid obtained by dissolving or dispersing such material in an organic solvent.

Next, according to the layer structure of the respective organic EL devices, the light emitting layer 4 and the electron transport layer 5 are formed by a vacuum vapor deposition method with the material constituting the respective layers, or by forming a film on the surface of the hole transport layer 3 or the light emitting layer 4 by spin coating or dip coating with a coating liquid obtained by dissolving or dispersing such material in an organic solvent.

In aspects of the present invention, since a high-molecular compound is contained as the charge transport material, the respective layers may be formed by a film forming method using a coating liquid.

The thickness of the formed hole transport layer 3, the light emitting layer 4, and the electron transport layer 5 is preferably within a range of 0.1 μm or less, particularly preferably within a range of 0.03 to 0.08 μm. Moreover, the thickness of the light emitting layer 6 with a charge transporting ability may be within a range of about 0.03 to 0.2 μm. The thickness of the hole injection layer or the electron injection layer if formed may be equivalent to or thinner than that of the hole transport layer 3 or the electron transport layer 5, respectively.

The dispersion state of the respective materials (such as the charge transport polyester and the light emitting material) in the layer may be a molecular dispersion state or a fine particle dispersion state. In the case of the film forming method using a coating liquid, the dispersion solvent is a common solvent for these materials in order to achieve the molecular dispersion state, and the dispersion solvent is selected in consideration of the dispersibility and solubility of the respective materials, in order to achieve the fine particle dispersion state. In order to disperse into fine particles, there may be utilized a ball mill, a sand mill, a paint shaker, an attritor, a homogenizer, or an ultrasonic method.

Finally, the device may be obtained by forming a rear electrode 7 by a vacuum vapor deposition method on the electron transport layer 5, the light emitting layer 4, or the light emitting layer 6 with a charge transporting ability.

The organic EL device according to an aspect of the present invention formed in such manner may sufficiently emit light by an application of, for example, a DC voltage of 4 to 20 V with a current density of 1 to 200 mA/cm² between the pair of electrodes.

### EXAMPLES

Hereunder is a description of the present invention with reference to the examples. However, these examples are not to be considered as limiting the present invention. Firstly, the charge transport polyester used in the examples is obtained in the following manner for example.

### Synthesis Example 1

2.0 g of the following compound (X-1), 8.0 g of ethylene glycol, and 0.1 g of tetrabutoxytitanium are put in a 50 ml flask and are heated under agitation for 5 hours at 190° C. under a nitrogen flow. After the consumption of the compound (X-1) is confirmed, the mixture is heated at 200° C. under a pressure reduced to 0.25 mmHg for distilling off ethylene glycol, and the reaction is continued for 5 hours.

Thereafter, the mixture is cooled to room temperature, and dissolved in 50 ml of tetrahydrofuran (THF). Then the insoluble substance is filtered off with a 0.2 μm polytetrafluoroethylene (PTFE) filter, and the filtrate is subjected to a reprecipitation by dripping into 500 ml of methanol under agitation, and thereby precipitating a polymer. The obtained polymer is separated by filtration, sufficiently washed with methanol and dried to obtain 1.9 g of hole-transport polyester (X-2). The molecular weight distribution is measured by GPC (gel permeation chromatography), which shows that the weight-average molecular weight is Mw=7.24×10⁴ (converted as styrene), and the ratio (Mn/Mw) of the number-average molecular weight Mn to the weight-average molecular weight Mw is 1.87. The work function of this hole-transport polyester is 5.5 eV.

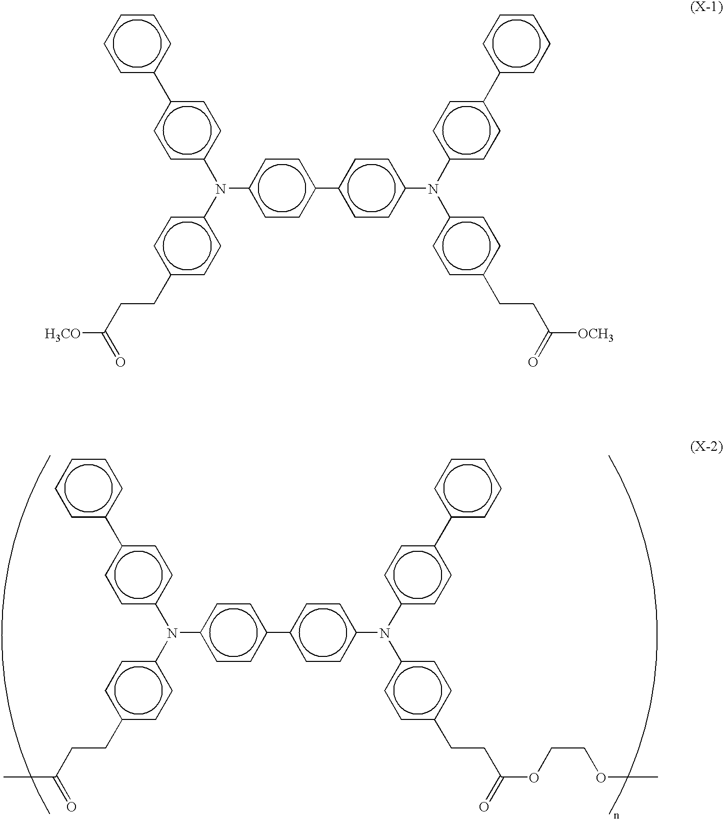

### Synthesis Example 2

2.0 g of the following compound (XI-1), 8.0 g of ethylene glycol, and 0.1 g of tetrabutoxytitanium are put in a 50-ml flask and are heated under agitation for 5 hours at 190° C. under a nitrogen flow. After the consumption of the compound (XI-1) is confirmed, the mixture is heated at 200° C. under a pressure reduced to 0.25 mmHg for distilling off ethylene glycol, and the reaction is continued for 5 hours.

Thereafter, the mixture is cooled to room temperature, and dissolved in 50 ml of THF. Then the insoluble substance is filtered off with a 0.2 μm PTFE filter, and the filtrate is subjected to a reprecipitation by dripping into 500 ml of methanol under agitation, and thereby precipitating a polymer.

The obtained polymer is separated by filtration, sufficiently washed with methanol and dried to obtain 1.9 g of hole-transport polyester (XI-2). The molecular weight distribution is measured by GPC, which shows that the weight-average molecular weight is Mw=7.08×10⁴ (converted as styrene), and Mn/Mw is 2.0. The work function of this hole-transport polyester is 5.37 eV.

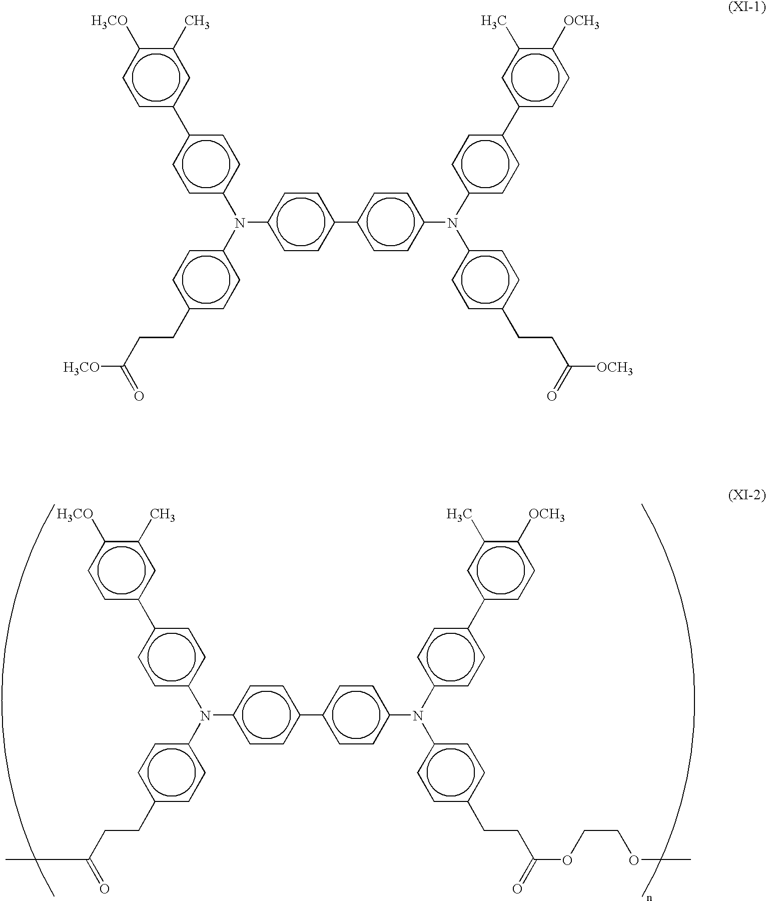

### Synthesis Example 3

2.0 g of the following compound (XII-1), 8.0 g of ethylene glycol, and 0.1 g of tetrabutoxytitanium are put in a 50-ml flask and are heated under agitation for 5 hours at 190° C. under a nitrogen flow. After the consumption of the compound (XII-1) is confirmed, the mixture is heated at 200° C. under a pressure reduced to 0.25 mmHg for distilling off ethylene glycol, and the reaction is continued for 5 hours.

Thereafter, the mixture is cooled to room temperature, and dissolved in 50 ml of THF. Then the insoluble substance is filtered off with a 0.2 μm PTFE filter, and the filtrate is subjected to a reprecipitation by dripping into 500 ml of methanol under agitation, and thereby precipitating a polymer.

The obtained polymer is separated by filtration, sufficiently washed with methanol and dried to obtain 1.9 g of hole-transport polyester (XII-2). The molecular weight distribution is measured by GPC, which shows that the weight-average molecular weight is Mw=5.1×10⁴ (converted as styrene), and Mn/Mw is 1.8. The work function of this hole-transport polyester is 5.4 eV.

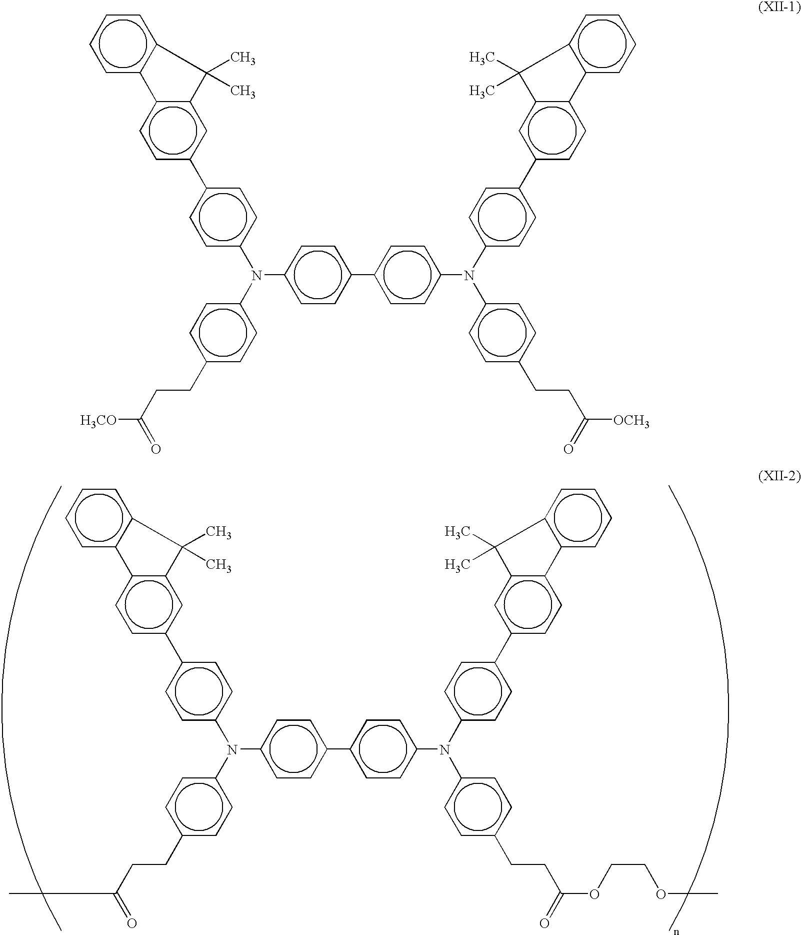

Next, an organic EL device is formed in the following manner, using the charge transport polyester obtained by the above method.

### Example 1

A glass substrate with an ITO electrode etched into the shape of a strip 2 mm in width is soaked and washed sequentially with; a washing liquid containing 5 weight % of a surfactant (solvent is extrapure water: SEMICLEAN M-LO, manufactured by Yokohama Oils & Fats Industry), extrapure water, acetone for the electronics industry (EL grade, manufactured by Kanto Kagaku), and 2-propanol for the electronics industry (EL grade, manufactured by Kanto Kagaku), using an ultrasonic washer (washing with the surfactant is performed for 10 minutes, and washing treatments with the other solvents are performed for 5 minutes each), and is then dried. Furthermore, a surface treatment by means of UV-ozone is performed for 15 minutes. The work function of the ITO electrode surface after the surface treatment on the glass substrate is 5.0 eV, and the contact angle for water is 16 degrees.

The surface treatment by means of UV-ozone is performed with a UV-ozone cleaner NL-UV253 manufactured by Filgen, Inc., by a processing flow of 3 minutes of oxygen purge, 15 minutes of UV irradiation, and 1.5 minutes of nitrogen purge.

Next, as the hole transport material, a material obtained by mixing a charge transport polyester [exemplary compound (X-2)] (Mw=7.24×10⁴) and a light emitting high molecular compound [the following exemplary compound (XIII, polyfluorene-based)] (Mw≈10⁵) with a weight ratio of 95:5, is prepared as a 5% by weight chlorobenzene solution. The resulting solution is filtered with a 0.1 μm polytetrafluoroethylene (PTFE) filter.

Subsequently, right after the surface treatment of the ITO electrode, this solution is applied onto the glass substrate formed with the ITO electrode by spincoating, so as to form a layer with a thickness of 30 nm functioning as both of the hole transport layer and light emitting layer. After sufficient drying, next, as the electron transport material, a charge transport polyester [exemplary compound (V-4)] (Mw=1.08×10⁵) is prepared as a 5% by weight dichloroethane solution. The resulting solution is filtered with a 0.1 μm polytetrafluoroethylene (PTFE) filter. Then, this solution is applied onto the light emitting layer by spincoating, so as to form an electron transport layer with a thickness of 30 nm.

Finally, deposition is performed sequentially with Ca and Al, and a rear electrode with a width of 2 mm and a thickness of 0.15 μm is formed so as to cross over the ITO electrode. The effective area of the formed organic EL device is 0.04 cm².

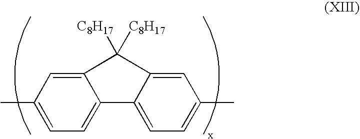

### Example 2

In the same manner as that of Example 1, a glass substrate with an ITO electrode etched into the shape of a strip 2 mm in width is washed, and a surface treatment is performed. Next, as the hole transport material, a charge transport polyester [exemplary compound (X-2)] (Mw=7.24×10⁴) is prepared as a 5% by weight chlorobenzene solution. The resulting solution is filtered with a 0.1 μm polytetrafluoroethylene (PTFE) filter.

Subsequently, right after the surface treatment of the ITO electrode, this solution is applied onto the glass substrate formed with the ITO electrode by spincoating, so as to form the hole transport layer with a thickness of 30 nm. After sufficient drying, next, as the light emitting material, a light emitting high molecular compound [exemplary compound (XIII, polyfluorene-based)] (Mw≈10⁵) is prepared as a 5% by weight xylene solution. The resulting solution is filtered with a 0.1 μm PTFE filter. Then, this solution is applied onto the hole transport layer by spincoating, so as to form a light emitting layer with a thickness of 50 nm.

After further sufficient drying, next, as the electron transport material, a charge transport polyester [exemplary compound (V-4)] (Mw=1.08×10⁵) is prepared as a 5% by weight dichloroethane solution. The resulting solution is filtered with a 0.1 μm polytetrafluoroethylene (PTFE) filter. Then, this solution is applied onto the light emitting layer by spincoating, so as to form an electron transport layer with a thickness of 30 nm.

Finally, deposition is performed sequentially with Ca and Al, and a rear electrode with a width of 2 mm and a thickness of 0.15 μm is formed so as to cross over the ITO electrode. The effective area of the formed organic EL device is 0.04 cm².

### Example 3

In the same manner as that of Example 1, a glass substrate with an ITO electrode etched into the shape of a strip 2 mm in width is washed, and a surface treatment is performed. Next, as the hole transport material, a charge transport polyester [exemplary compound (X-2)] (Mw=7.24×10⁴) is prepared as a 5% by weight chlorobenzene solution. The resulting solution is filtered with a 0.1 μm polytetrafluoroethylene (PTFE) filter.

Subsequently, right after the surface treatment of the ITO electrode, this solution is applied onto the glass substrate formed with the ITO electrode by spincoating, so as to form the hole transport layer with a thickness of 30 nm. After sufficient drying, next, as the light emitting material, a light emitting high molecular compound [exemplary compound (XIII, polyfluorene-based)] (Mw≈10⁵) is prepared as a 5% by weight xylene solution. The resulting solution is filtered with a 0.1 μm PTFE filter. Then, this solution is applied onto the hole transport layer by spincoating, so as to form a light emitting layer with a thickness of 50 nm.

After further sufficient drying, finally, deposition is performed sequentially with Ca and Al, and a rear electrode with a width of 2 mm and a thickness of 0.15 μm is formed so as to cross over the ITO electrode. The effective area of the formed organic EL device is 0.04 cm².

### Example 4

In the same manner as that of Example 1, a glass substrate with an ITO electrode etched into the shape of a strip 2 mm in width is washed, and a surface treatment is performed. Next, as the hole transport material, a material obtained by mixing a charge transport polyester [exemplary compound (X-2)] (Mw=7.24×10⁴) and a light emitting high molecular compound [exemplary compound (XIII, polyfluorene-based)] (Mw≈10⁵) with a weight ratio of 95:5, is prepared as a 5% by weight chlorobenzene solution. The resulting solution is filtered with a 0.1 μm polytetrafluoroethylene (PTFE) filter.

Subsequently, right after the surface treatment of the ITO electrode, this solution is applied onto the glass substrate formed with the ITO electrode by spincoating, so as to form a layer with a thickness of 50 nm functioning as both of the charge transport layer and the light emitting layer. After sufficient drying, finally, deposition is performed sequentially with Ca and Al, and a rear electrode with a width of 2 mm and a thickness of 0.15 μm is formed so as to cross over the ITO electrode. The effective area of the formed organic EL device is 0.04 cm².

### Example 5

A device is formed in the same manner as that of Example 1, except that a light emitting high molecular compound [the following exemplary compound (XIV, PPV-based)] (Mw≈10⁵) is used as a light emitting material.

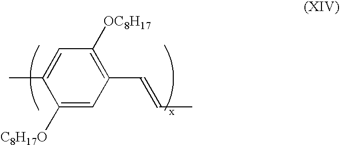

### Example 6

A device is formed in the same manner as that of Example 2, except that a light emitting high molecular compound [exemplary compound (XIV, PPV-based)] (Mw≈10⁵) is used as a light emitting material.

### Example 7

A device is formed in the same manner as that of Example 3, except that a light emitting high molecular compound [exemplary compound (XIV, PPV-based)] (Mw≈10⁵) is used as a light emitting material.

### Example 8

A device is formed in the same manner as that of Example 4, except that a light emitting high molecular compound [exemplary compound (XIV, PPV-based)] (Mw≈10⁵) is used as a light emitting material.

### Example 9

A device is formed in the same manner as that of Example 7, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried, and that the charge transport polyester [exemplary compound (XI-2)] (Mw=7.0×10⁴) is used as a hole-transport material.

The work function of the ITO electrode surface after the washing and drying is 4.7 eV, and the contact angle for water is 22 degrees. Moreover, right after the washing and drying of the ITO electrode, the solution containing the hole-transport polyester is applied.

### Example 10

A device is formed in the same manner as that of Example 7, except that a charge transport polyester [exemplary compound (XII-2)] (Mw=5.1×10⁴) is used as a hole transport material.

### Comparative Example 1

A device is formed in the same manner as that of Example 1, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried.

The work function of the ITO electrode surface after the washing and drying is 4.7 eV, and the contact angle for water is 22 degrees. Moreover, right after the washing and drying of the ITO electrode, the solution containing the hole-transport polyester is applied.

### Comparative Example 2

A device is formed in the same manner as that of Example 2, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 3

A device is formed in the same manner as that of Example 3, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 4

A device is formed in the same manner as that of Example 4, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 5

A device is formed in the same manner as that of Example 5, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 6

A device is formed in the same manner as that of Example 6, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 7

A device is formed in the same manner as that of Example 7, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 8

A device is formed in the same manner as that of Example 8, except that the glass substrate formed with the ITO electrode by etching is not applied with a surface treatment by means of UV-ozone after being washed sequentially with; a washing liquid containing 5 weight % of a surfactant (solvent is extrapure water), extrapure water, acetone for the electronics industry, and 2-propanol for the electronics industry, and then dried. Moreover, right after the washing and drying of the ITO electrode, the solution containing the hole-transport polyester is applied.

### Comparative Example 9

A device is formed in the same manner as that of Example 7, except that the glass substrate formed with the ITO electrode by etching is used without washing and surface treatment being applied at all.

The work function of the ITO electrode surface which is not washed and applied with a surface treatment by means of UV-ozone before being coated with a solution containing the hole-transport polyester, is 4.7 eV, and the contact angle for water is 43 degrees.

The organic EL device formed in the above manner is made to emit light by application of a DC voltage of 5V with a positive side at the ITO electrode and a negative side at the Ca/Al rear electrode in vacuum (133.3×10⁻¹ Pa), and the light emission is measured. At this time, the maximum brightness and the luminescent color are evaluated. These results are shown in Table 1.

Moreover, the light-emitting life of the organic EL device is measured in dry nitrogen. A current value is set so as to obtain an initial brightness of 100 cd/m² and a device life (hours) is defined by the time at which the brightness decreased to a half of the initial value under a constant-current drive. The driving current density at this time is shown together with the service life of the device in Table 1.

TABLE 1

| | Initial Stage voltage | Maximum brightness | Driving current | Device life | |
|---|---|---|---|---|---|
| | (cd/m²) | (cd/m²) | density (mA/cm²) | (hours) | Comment |
| Example 1 | 3.3 | 3050 | 330 | 44 | |
| Example 2 | 2.1 | 7500 | 550 | 70 | |
| Example 3 | 2.4 | 7000 | 400 | 61 | |
| Example 4 | 3.6 | 2800 | 300 | 53 | |
| Example 5 | 3.3 | 3070 | 360 | 41 | |
| Example 6 | 2.0 | 8010 | 650 | 79 | |
| Example 7 | 2.5 | 7400 | 500 | 65 | |
| Example 8 | 3.4 | 3000 | 320 | 55 | |
| Example 9 | 3.2 | 6700 | 600 | 70 | |
| Example 10 | 2.8 | 7100 | 550 | 55 | |
| Comparative Example 1 | 3.7 | 830 | 90 | 29 | |
| Comparative Example 2 | 3.3 | 1000 | 180 | 40 | |
| Comparative Example 3 | 3.1 | 940 | 150 | 37 | |
| Comparative Example 4 | 3.5 | 800 | 80 | 19 | |
| Comparative Example 5 | 3.3 | 880 | 80 | 25 | |
| Comparative Example 6 | 3.0 | 1020 | 210 | 39 | |
| Comparative Example 7 | 3.0 | 950 | 170 | 37 | |
| Comparative Example 8 | 3.3 | 810 | 90 | 18 | |
| Comparative Example 9 | 4.4 | 800 | 100 | <1 | Conducted |
| | | | | | immediately |

As shown in the above Examples, the charge transport polyester comprising a repeating unit containing at least one type selected from structures represented by the formulae (I-1) and (I-2), as a substructure, has an ionization potential and a charge mobility suitable for an organic EL device, and a satisfactory thin film could be formed by using spincoating, dipping, or the like.

What is claimed is:

1. An organic electroluminescent device comprising one or more organic compound layers sandwiched between a pair of electrodes, at least one of the electrodes being transparent or semi-transparent,
the organic compound layers comprising a layer that is in contact with at least one electrode of the pair of electrodes and includes a charge transport polyester, the charge transport polyester including a repeating unit that includes a structure represented by the following formulae (I-1) or (I-2) as a substructure, and a difference between an ionization potential of the charge transport polyester contained in the layer in contact with the one electrode, and a work function of a surface of the one electrode being within a range of from about 0 eV to about 0.7 eV. 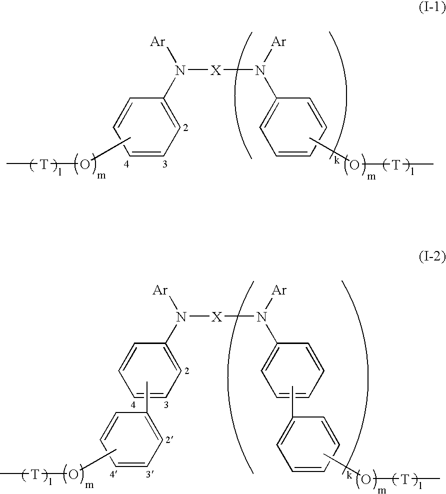
in formulae (I-1) and (I-2), Ar representing a substituted or unsubstituted monovalent aromatic group; X representing a substituted or unsubstituted divalent aromatic group; k, m, and l each independently representing 0 or 1; and T representing a divalent linear hydrocarbon having 1 to 6 carbon atoms or a divalent branched hydrocarbon having 2 to 10 carbon atoms.

2. The organic electroluminescent device according to claim 1, wherein the organic electroluminescent device is formed by coating a solution including the charge transport polyester onto the one electrode surface, and the one electrode surface has a contact angle for water of from 0 degree to 30 degrees immediately before coating with the solution containing the charge transport polyester.

3. The organic electroluminescent device according to claim 1, wherein the organic electroluminescent device is formed by surface treating the one electrode surface, and coating the surface treated electrode surface with a solution containing the charge transport polyester.

4. The organic electroluminescent device according to claim 1, wherein the one electrode is an anode.

5. The organic electroluminescent device according to claim 1, wherein the one or more organic compound layers comprise a light emitting layer and at least one of an electron transport layer or an electron injection layer, and
at least one layer selected from the light emitting layer or the at least one of the electron transport layer or the electron injection layer includes a charge transport polyester including a repeating unit that includes a structure represented by the formulae (I-1) or (I-2) as a substructure.

6. The organic electroluminescent device according to claim 5, wherein the light emitting layer contains a charge transport material.

7. The organic electroluminescent device according to claim 1, wherein the one or more organic compound layers comprise at least one of a hole transport layer or a hole injection layer, a light emitting layer, and at least one of an electron transport layer or an electron injection layer, and
at least one layer selected from the at least one of the hole transport layer or the hole injection layer, the light emitting layer, or the at least one of the electron transport layer or the electron injection layer includes a charge transport polyester including a repeating unit that includes a structure represented by the formulae (I-1) or (I-2) as a substructure.

8. The organic electroluminescent device according to claim 7, wherein the light emitting layer includes a charge transport material.

9. The organic electroluminescent device according to claim 1, wherein the one or more organic compound layers comprise at least one of a hole transport layer or a hole injection layer, and a light emitting layer, and
at least one layer selected from the at least one of the hole transport layer or the hole injection layer, and the light emitting layer includes a charge transport polyester including a repeating unit that includes a structure represented by the formulae (I-1) or (I-2) as a substructure.

10. The organic electroluminescent device according to claim 9, wherein the light emitting layer includes a charge transport material.

11. The organic electroluminescent device according to claim 1, wherein the one or more organic compound layers comprise a light emitting layer with a charge transporting ability.

12. The organic electroluminescent device according to claim 11, wherein the light emitting layer with a charge transporting ability includes a charge transport material.

13. The organic electroluminescent device according to claim 1, wherein the charge transport polyester is represented by the following formula (II-1) or (II-2): 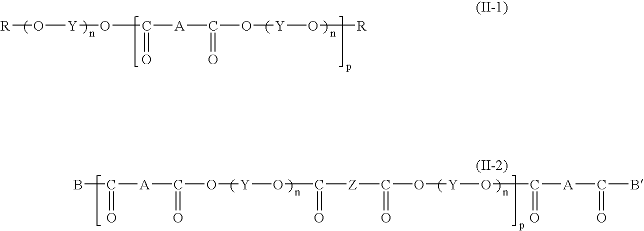
wherein, in formulae (II-1) and (II-2), A represents the structure represented by the formulae (I-1) or (I-2); R represents a hydrogen atom, an alkyl group, a substituted or unsubstituted aryl group, or a substituted or unsubstituted aralkyl group; Y represents a divalent alcohol residue; Z represents a divalent carboxylic acid residue; B and B′ independently represents a —O—(Y—O)ₙ—R group or a —O—(Y—O)ₙ—CO-Z-CO—O—R′ group in which R, Y, and Z represent the same as the above and R′ represents an alkyl group, a substituted or unsubstituted aryl group, or a substituted or unsubstituted aralkyl group; n represents an integer 1 to 5; and p represents an integer of 5 to 5,000.

14. An organic electroluminescent device comprising one or more organic compound layers sandwiched between a pair of electrodes, at least one of the electrodes being transparent or semi-transparent,
the organic electroluminescent device being formed by coating a solution including a charge transport polyester comprising a repeating unit that includes a structure represented by the following formulae (I-1) or (I-2) as a substructure, onto a surface of at least one electrode of the pair of electrodes, and
a difference between an ionization potential of the charge transport polyester contained in the solution, and a work function of the one electrode surface immediately before coating the solution being within a range of from about 0 eV to about 0.7 eV. 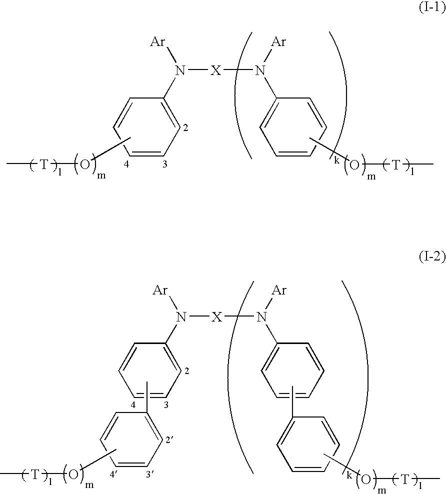
in formulae (I-1) and (I-2), Ar representing a substituted or unsubstituted monovalent aromatic group; X representing a substituted or unsubstituted divalent aromatic group; k, m, and l each independently representing 0 or 1; and T representing a divalent linear hydrocarbon having 1 to 6 carbon atoms or a divalent branched hydrocarbon having 2 to 10 carbon atoms.

15. The organic electroluminescent device according to claim 14, wherein the one electrode surface has a contact angle for water of from about 0 degree to about 30 degrees, immediately before coating with the solution.

16. The organic electroluminescent device according to claim 14, wherein the coating of the solution is conducted after surface treating the one electrode surface.

17. A method for producing an organic electroluminescent device, the method comprising forming an organic electroluminescent device comprising one or more organic compound layers sandwiched between a pair of electrodes, at least one of the electrodes being transparent or semi-transparent, by coating a solution including a charge transport polyester onto a surface of at least one electrode of the pair of electrodes,
the charge transport polyester comprising a repeating unit that includes a structure represented by the following formulae (I-1) or (I-2) as a substructure, and
a difference between an ionization potential of the charge transport polyester contained in the solution, and a work function of the one electrode surface immediately before coating the solution being within a range of from about 0 eV to about 0.7 eV. 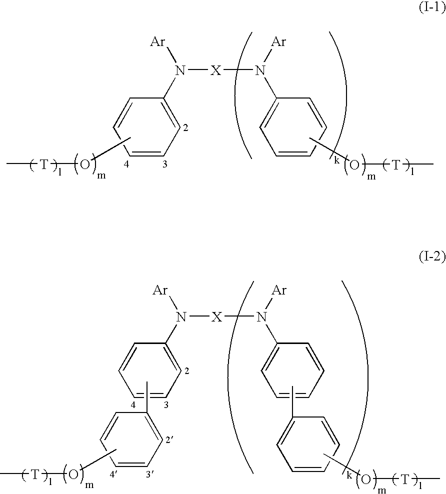
in the formulae (I-1) or (I-2), Ar representing a substituted or unsubstituted monovalent aromatic group, X representing a substituted or unsubstituted divalent aromatic group, k, m, and l each independently representing 0 or 1, and T representing a divalent linear hydrocarbon having 1 to 6 carbon atoms or a divalent branched hydrocarbon having 2 to 10 carbon atoms.

18. The method for producing an organic electroluminescent device according to claim 17, wherein a contact angle of the one electrode surface for water is from about 0 degree to about 30 degrees, immediately before coating with the solution.

19. The method for producing an organic electroluminescent device according to claim 17, wherein the one electrode surface is subjected to surface treatment before being coated with the solution.
